(19) United States
(12) Patent Application Publication
(10) Pub. No.: US 2019/0057357 A1
(43) Pub. Date: Feb. 21, 2019

(54) SCHEDULING SHARED RESOURCES USING A HIERARCHY OF ATTRIBUTES

(71) Applicant: Microsoft Technology Licensing, LLC, Redmond, WA (US)

(72) Inventors: Hongchao GUAN, Redmond, WA (US); Abhishek Kumar CHATURVEDI, Vancouver (CA); Chenlei GUO, Redmond, WA (US); Byungki BYUN, Issaquah, WA (US); Karen Catelyn STABILE, Redmond, WA (US)

(73) Assignee: Microsoft Technology Licensing, LLC, Redmond, WA (US)

(21) Appl. No.: 15/682,321

(22) Filed: Aug. 21, 2017

(51) Int. Cl. G06Q 10/10; G06Q 10/02

(52) U.S. Cl. CPC G06Q 10/1095; H04L 12/1818; G06Q 10/025

(57) ABSTRACT

Described herein are systems and methods for scheduling a resource that is shared by multiple people. The shared resource is included in a plurality of shared resources, and a number of attributes are associated with the plurality of shared resources. The attributes are grouped and arranged in a hierarchy. When a shared resource is to be used or scheduled, the hierarchy is analyzed to determine one or more shared resources in the plurality of shared resources to suggest to a requestor scheduling the shared resource.

### BACKGROUND

Many enterprises provide resources that are shared by the individuals associated with the enterprises. For example, a business can have a number of conference rooms that are shared by the employees of the business. When the business is a large or very large business, the conference rooms can number in the tens or hundreds. Typically, an employee can schedule one of the conference rooms for a meeting. However, it can be difficult for the employee, or for a scheduling program that is used by the employee to schedule the meeting, to determine and select a conference room that is convenient or favorable for the employee and the attendees of the meeting.

It is with respect to these and other general considerations that embodiments have been described. Also, although relatively specific problems have been discussed, it should be understood that the embodiments should not be limited to solving the specific problems identified in the background.

### SUMMARY

Embodiments disclosed herein provide methods and systems for suggesting a shared resource to be used by one or more persons. In one aspect, a system includes one or more processing units and one or more storage devices. The storage device(s) store a directory comprising shared resources and a hierarchy of attributes associated with the shared resources, and instructions that when executed by the one or more processing units, cause the one or more processing units to perform a method. The method includes receiving a request to schedule a particular shared resource type that is included in the directory, receiving one or more selected attributes associated with the particular shared resource type, and analyzing the hierarchy of attributes associated with the particular shared resource type to determine one or more shared resources of the particular shared resource type that correspond to the one or more selected attributes. Based at least on the analysis, at least one shared resource of the particular shared resource type to suggest is determined. In one example embodiment, the particular shared resource type is conference rooms and one or more conference rooms from a plurality of conference rooms to suggest is determined.

In another aspect, a method includes receiving, from a scheduling program, a request to schedule a conference room. The conference room is included in a plurality of conference rooms. In response to the request, a hierarchy of attributes associated with the plurality of conference rooms is analyzed to determine which conference rooms in the plurality of conference rooms correspond to one or more selected attributes. At least one conference room to suggest is determined based at least in part on the analysis. The suggested at least one conference room is then provided to the scheduling program.

In yet another aspect, a method includes receiving a request to schedule a meeting in a conference room, determining a location of the requestor and a location of each conference room in a plurality of conference rooms, and determining a distance between the location of the requestor and a location of each conference room. One or more selected attributes associated with the plurality of conference rooms are received and a hierarchy of attributes associated with the one or more conference rooms is analyzed to determine which conference rooms correspond to the selected attributes. Based at least in part on the analysis and the determined distances, determining one or more conference rooms to suggest for the meeting. For example, based at least in part on the analysis, the conference room(s) that have location(s) that are closest to the requestor and/or the attendees (e.g., have the shortest distances from the requestor and/or the attendees) and that have one or more attributes that correspond to the one or more selected attributes may be the determined one or more conference rooms to suggest for the meeting.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures. The elements of the drawings are not necessarily to scale relative to each other. Identical reference numerals have been used, where possible, to designate identical features that are common to the figures.

FIG. 1 illustrates an example system that can be used to schedule a shared resource;

FIGS. 2A-2E depict an example hierarchy of attributes;

FIG. 3 illustrates an example graph of a hierarchy of attributes;

FIG. 4 depicts an example user interface for scheduling a shared resource;

FIG. 5 is a flowchart illustrating a method of scheduling a shared resource;

FIG. 6 is a block diagram depicting example physical components of a computing device with which aspects of the disclosure may be practiced;

FIGS. 7A-7B are simplified block diagrams illustrating a mobile computing device with which aspects of the present disclosure may be practiced; and

FIG. 8 is a block diagram depicting a distributed computing system in which aspects of the present disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Aspects of the disclosure provide techniques for scheduling a shared resource using a hierarchy of attributes that are associated with the shared resource. In the example embodiments described herein, the shared resource is conference rooms. The example processes include scheduling a meeting in a conference room using a hierarchy of attributes that include various types of equipment that may be used in the meeting. The types of equipment include, but are not limited to, a projector, a podium, a display, a microphone, a flip chart, and a white board. In addition to the hierarchy of attributes, other criteria can be considered when scheduling the meeting, such as the locations and/or the distances to the conference rooms and/or the user's historical use of the conference rooms. However, embodiments are not limited to scheduling a meeting in a conference room, where the shared resource is the conference room. Aspects of the disclosure can be used with any suitable type of shared resource. Example shared resources include, but are not limited to, equipment, tools, automobiles, and/or conference rooms.

Embodiments of the disclosure may be practiced by individuals associated with an enterprise that owns or manages the shared resource, although this is not required. The term “enterprise” is to be construed broadly as including a company, an educational institution, an organization, a business, an association, an institution, an ad-hoc group, and the like.

A more convenient or favorable shared resource can be scheduled when a hierarchy of attributes is considered when scheduling the shared resource. The person scheduling the shared resource can identify which attributes should be present, included, and/or associated with the shared resource, which ensures the shared resource meets the person's needs or desires. Additionally or alternatively, aspects of the disclosure result in a more efficient and effective process of scheduling a shared resource with the needed or desired attributes. For example, the amount of time needed to schedule a shared resource is reduced. In some instances, fewer steps or operations are needed to schedule a shared resource.

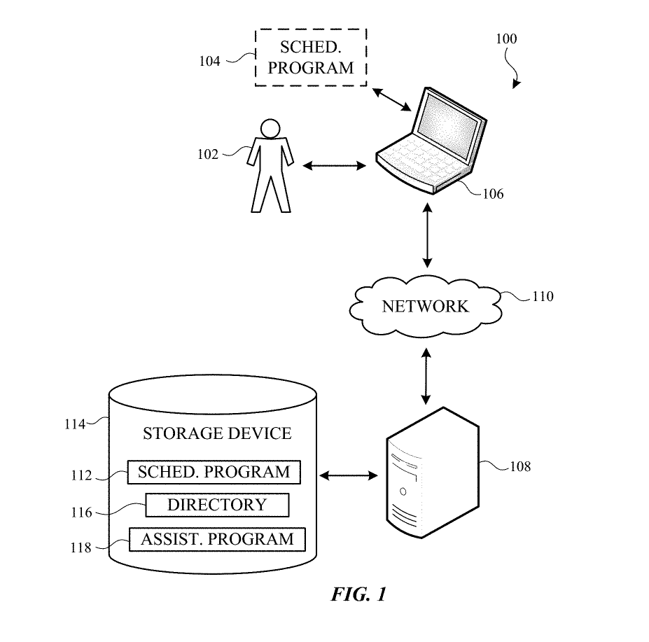

FIG. 1 illustrates an example system that can be used to schedule a shared resource. The system 100 allows a user 102 (“requestor”) to schedule the shared resource using a scheduling program or service 104 running on a client-computing device 106. The client-computing device 106 is configured to access one or more server-computing devices (represented by server-computing device 108) through one or more networks (represented by network 110) to interact with a scheduling program or service 112 stored on one or more storage devices (represented by storage device 114) and executed by the server-computing device 108. In some embodiments, the scheduling program or service 112 is a cloud-based or Internet-based service. In such embodiments, the scheduling program 104 may be omitted (represented by dashed lines).

A directory 116 and an assistant program 118 are also stored on the storage device 114. The directory 116 includes one or more records for a shared resource. For example, the directory 116 can include multiple records for different conference rooms the user 102 may schedule. The directory 116 further stores a hierarchy of attributes that are associated with the shared resource and/or are needed or desired for the shared resource. For example, in one embodiment, the shared resource is a conference room and the attributes include features of the conference room (e.g., seating layout) and/or accessories that are needed or desired for a meeting that includes the requestor and one or more attendees.

The assistant program 118 receives a scheduling a proposal from the scheduling program or service 112 (or data relating to the proposal). In response, the assistant program 118 accesses the directory 116 to analyze one or more attributes associated with the shared resource to be scheduled. Based at least in part on the analysis, the assistant program 118 proposes one or more shared resources that is best or favorable for the requestor.

In some embodiments, the assistant program 118 is a computer-executable program that may be stored in the storage device 114 and executed by the server-computing device 108, although this is not required. An assistant program can be stored in one or more suitable storage devices, including one or more storage devices within, or connected to the client-computing device 106, the server-computing device 108, and/or the storage device 114. Additionally, the assistant program 118 may be executed by the client-computing device 106, the server-computing device 108, or the execution of the assistant program 118 can be distributed between the client-computing device 106 and the server-computing device 108.

In one or more embodiments, the network 110 is illustrative of any suitable type of network, for example, an intranet, and/or a distributed computing network (e.g., the Internet) over which the user 102 may communicate with other users and with other computing systems. Additionally, the client-computing device 106 can be a personal or handheld computing device. For example, the client-computing device 106 may be one of: a mobile telephone; a smart phone; a tablet; a phablet; a smart watch; a wearable computer; a personal computer; a desktop computer; a laptop computer; a gaming device/computer (e.g., Xbox); a television; and the like. This list of example client-computing devices is for example purposes only and should not be considered as limiting. Any suitable client-computing device that provides and/or interacts with one or more scheduling programs or services may be utilized.

As should be appreciated, FIG. 1 is described for purposes of illustrating the present methods and systems and is not intended to limit the disclosure to a particular sequence of steps or a particular combination of hardware or software components.

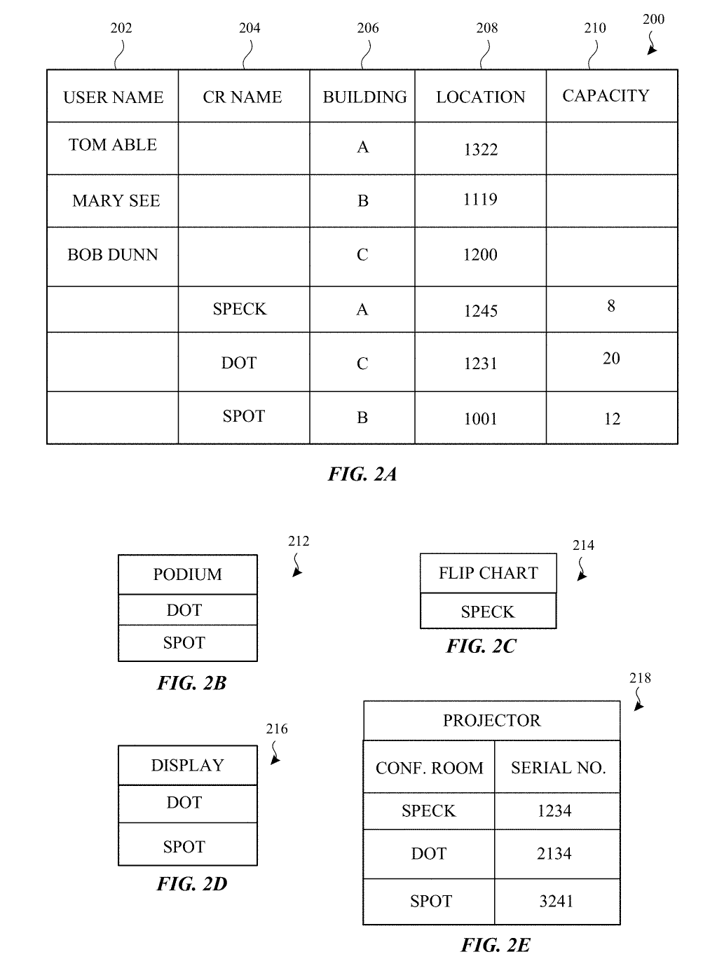

In an example embodiment, the shared resources are conference rooms that are within an enterprise or are accessible by individuals associated with the enterprise. The attributes associated with the conference rooms include, but are not limited to, the capacity of each conference room, one or more seating layouts that can be used in a conference room (e.g., a theater or meeting layout), locations of the conference rooms, and pieces of equipment that may be used during a meeting, such as a projector, a display, a microphone, a podium, a white board, a videoconference system, and the like. The shared resource discussed in conjunction with FIGS. 2-5 are conference rooms.

As described earlier, the directory stores one or more attributes associated with a conference room. In one embodiment, the directory can group and organize the attributes in a hierarchy. The attributes can be grouped in any suitable arrangement. For example, the attributes may be grouped by attribute, by conference room, or by building or location.

FIGS. 2A-2E depict an example hierarchy of attributes for a conference room that can be stored in a directory. The hierarchy in the directory may include a first tier 200 that is shown in FIG. 2A. The first tier can include the names 202 of individuals that can access the conference rooms, the conference rooms (CR) 204, the building(s) 206 where each person or conference room is situated, and the location 208 of the person or the conference room within a particular building. For each conference room 204, the directory 200 can specify the capacity of the conference room, such as the maximum capacity of persons that can be seated in the conference room. Additionally or alternatively, the first tier can include telephone numbers, email addresses, managers, and other information regarding the individuals and/or the conference rooms.

The hierarchy of attributes further includes one or more subsequent or lower-level tiers. For example, FIGS. 2B-2E depict tiers in the hierarchy that group conference rooms by available equipment. As shown in FIG. 2B, a subsequent tier 212 lists which conference rooms include a podium (e.g., conference rooms Dot and Spot). Another subsequent tier 214 indicates the Speck conference room has a flip chart (FIG. 2C). Similarly, the subsequent tier 216 illustrated in FIG. 2D identifies the conference rooms that have a display (e.g., conference rooms Dot and Spot). Finally, the tier 218 in FIG. 2E lists the conference rooms that have a projector (e.g., Dot, Spot, Speck). FIG. 2E also indicates that a tier can include additional information, such as serial numbers, product names, makes and models, important dates (e.g., date of last quality check), and the like.

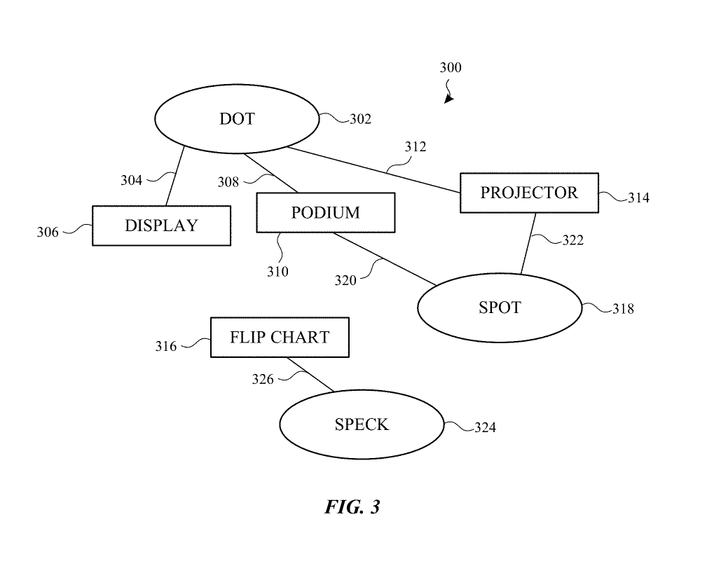

FIG. 3 illustrates a graph of the hierarchy of attributes. The graph 300 depicts the conference rooms and equipment as nodes. A link represents the relationship between a conference room and a piece of equipment. In FIG. 3, the links indicate a conference room includes a given piece of equipment.

The node 302 represents the conference room “Dot”. The node 302 has a link 304 to the display node 306, a link 308 to the podium node 310, and a link 312 to the projector node 314. The node 302 does not have a link to the flip chart node 316. Thus, the graph indicates, via the links 304, 308, and 312, that the conference room Dot includes a display, a podium, and a projector. The graph further indicates, via the absence of a link, that the conference room Dot does not have a flip chart.

The node 318 represents the conference room “Spot”. The node 318 has a link 320 to the podium node 310 and a link 322 to the projector node 314. The node 316 does not have a link to the display node 306 or to the flip chart node 316. Thus, the graph indicates, via the links 320 and 322, that the conference room Spot includes a podium and a projector. The graph further indicates, via the absence of a link, that the conference room Spot does not have a display or a flip chart.

The node 324 represents the conference room “Speck”. The node 324 has a link 326 to the flip chart node 316. The node 324 does not have a link to the display node 306, the podium node 310, and the projector node 314. Thus, graph indicates, via the link 326, that the conference room Speck includes a flip chart. The graph further indicates, via the absence of a link, that the conference room Speck does not include a display, a projector, or a podium.

The graph 300 illustrates the hierarchy of attributes in the directory. As will be described in more detail later, in some embodiments, the various nodes and their associated links are analyzed to determine which conference room (or rooms) is the best conference room to propose to a user who is scheduling a meeting.

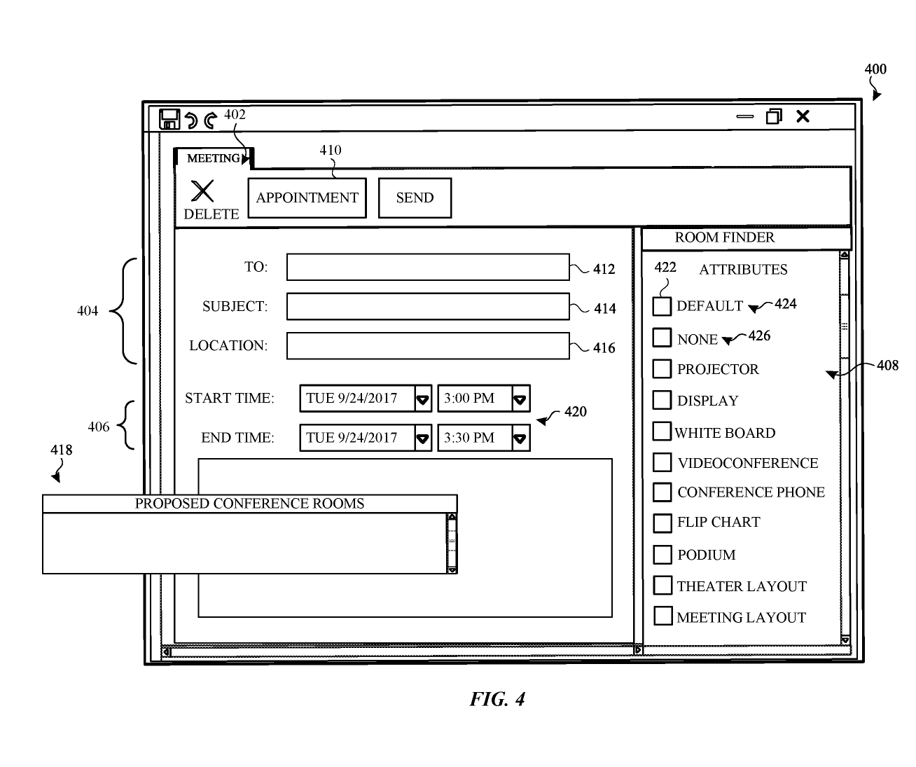

FIG. 4 depicts an example user interface for scheduling a conference room. The user interface 400 includes an operation section 402, a header section 404, a scheduling section 406, and a room finder section 408. The operation section 402 includes one or more operations or buttons 410. In the illustrated embodiment, the operations sections includes a delete operation to delete a proposed meeting, an appointment operation to schedule or propose a meeting, and a send operation that allows the requestor to send the proposed meeting to one or more other persons (“attendees”).

The header section 404 includes a “to” field 412, a “subject” field 414, and a “location” field 416. A user adds the names of the attendees in the “to” field 412 and the subject of the meeting in the “subject” field 414. In some embodiments, the “location” field 416 is filled with a given conference room after the user has selected the conference room from one or more conference rooms that are proposed in a panel 418.

The scheduling section 406 allows the requestor to select the time and the date of the proposed meeting. In one non-limiting example, the scheduling section 406 includes drop-down menus 420 that permit the requestor to select the time and the date.

The room finder section 408 includes a list of attributes and a selection element 422 that permits the requestor to select which attributes are to be included in the conference room. In the illustrated embodiment, the attributes include equipment and seat layout options (e.g., a meeting or theater layout) and the selection element 422 is a checkbox that is positioned adjacent to each attribute. The requestor can check the checkboxes adjacent the attributes to select which attributes in the list are to be in a conference room. Although FIG. 4 depicts the room finder section 408 as part of the user interface 400, embodiments are not limited to this arrangement. The room finder section 408 may be presented in a pop up panel in other embodiments.

Additionally, the attributes of a conference room can be selected or defined using another technique. For example, the proposed conference room(s) may be determined by the assistant program using other criteria, such as the requestor's prior history of conference room use and/or the distance between the requestor and one or more conference rooms. The panel 418 can present the proposed conference room(s) to the requestor and list other attributes associated with each presented conference room (e.g., the equipment available in each conference room). The requestor selects the attributes associated with a conference room by selecting a conference room presented in the panel 418.

In some embodiments, the room finder section 408 may include a default option 424 that permits a requestor to select a default set of attributes. The default set of attributes can include one or more attributes the requestor typically wants in a conference room. The attribute(s) included in the default set of attributes may be selected using any suitable technique, such as a through a user preference panel. In some instances, one or more default options may be presented in the room finder section 408. Each default option can be referred to by a name or title that is selected by the requestor. For example, a requestor can schedule a recurring meeting for a project, create a default option for that meeting, and identify the default option using the name of the project.

Additionally or alternatively, the room finder section 408 can include a “none” option 426. When selected, the “none” option indicates the requestor does not want any particular attributes in the conference room. In such embodiments, other attributes such as a user's history of conference room use, the distance between a conference room and the requestor and/or the attendees, and/or a requestor's or attendee's preference for a conference room may be considered when proposing a conference room. For example, the conference room(s) that have location(s) that are closest to the requestor and/or the attendees (e.g., have the shortest distances from the requestor and/or the attendees) may the proposed conference room(s).

An assistant program (e.g., assistant program 118 in FIG. 1) will analyze the selected attributes, and other data such as the attendees, the date, and the time of the proposed meeting, to determine one or more conference rooms to propose to the requestor. As described earlier, the proposed conference room(s) may be presented to the requestor in the panel 418. Although the panel 418 is depicted as a pop-up window or user interface, embodiments are not limited to the implementation. The panel 418 can be included in the user interface 400 or presented to the user using any suitable technique.

In some instances, the assistant program can determine a conference room to propose by considering the hierarchy based on the unselected attributes or both the selected and unselected attributes. For example, a requestor may select the “podium” attribute and leave all other attributes unselected. When there are two conference rooms that have a podium (Conference Room A and Conference Room B), and Conference Room B also has a display, the assistant program can eliminate Conference Room B from consideration and propose Conference Room A because the requestor did not select the “display” attribute. In this manner, the assistant program reserves Conference Room B for another meeting proposal that has the “display” attributed selected. By considering both the selected and unselected attributes, the assistant program is able to accommodate or satisfy more requests for conference rooms that include particular attributes.

The requestor can select a proposed conference room from the view 418, which may cause the selected conference room to the listed in the “location” field 416. In a non-limiting example, a requestor may select a proposed conference room by clicking on the proposed conference room while the one or more proposed conference rooms are displayed in the view 418. A requestor may select a proposed conference room using different techniques in other embodiments. For example, the requestor can drag a proposed conference room from the view and drop the proposed conference room in the “location” field 416, the requestor may type the proposed conference room in the “location” field 416, and/or the requestor can hover a cursor over the proposed conference room to select the proposed conference room.

Additionally, the one or more proposed conference rooms may be presented to the requestor differently in other embodiments. For example, the proposed conference room(s) can be listed in the “location” field and a requestor can select a given conference room from the list. Alternatively, the conference room that meets one or more criteria (e.g., closest to the user) may be listed in the “location” field 416 and any other proposed conference rooms can be presented in the view 418.

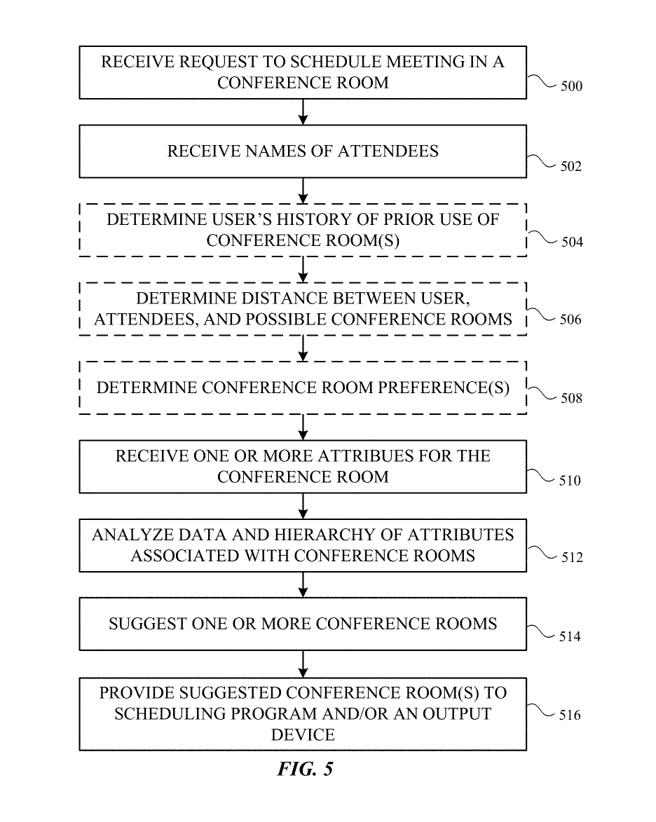

FIG. 5 is a flowchart illustrating a method of scheduling a conference room. The instructions of the method are included in an assistant program (e.g., assistant program 118 in FIG. 1) and executed by one or more computing devices (e.g., server-computing device 108 in FIG. 1). Initially, a request to schedule a meeting in a conference room is received at block 500. Alternatively, the data in the request that the assistant program will use to propose a conference room are received (block 500). Identifying information regarding the persons who will attend the meeting is received at block 502. For example, the identifying information includes the names and/or the email addresses of the attendees.

In some embodiments, a requestor's prior use of the conference rooms can be determined at block 504. Additionally or alternatively, the distance between the location of the requestor and/or the location of the attendees and the conference rooms may be determined at block 506. As described earlier, a directory can include a building and a location within a building for the requestor, the attendees, and the conference rooms. This information can be used to determine a distance of the requestor from each conference room and/or a distance of each attendee from each conference room. In some instances, the preferences of the requestor and/or the attendees may be determined at block 508. Blocks 504, 506, and/or 508 are optional and may be omitted in other embodiments (optionality indicated by dashed lines). For example, in one embodiment, block 508 is omitted while in another embodiment blocks 504 and 508 are omitted.

Next, as shown in block 510, one or more attributes of the conference room are received. The attribute or attributes can be provided using any suitable method. For example, the requestor may select the attribute(s) from a user interface (e.g., the room finder section 408 in FIG. 4).

The data determined in blocks 504, 506, 508 and/or the hierarchy of attributes are then analyzed at block 512. As described earlier, the hierarchy of attributes can be stored in a directory (e.g., the directory 116 in FIG. 1). In one aspect, the operation of analyzing the hierarchy of attributes can include generating a graph of nodes and links, where the conference rooms and the attributes are the nodes and the links indicate the relationships between the conference rooms and the attributes (see e.g., FIG. 3). The links in the graph are then analyzed to determine which conference rooms match the attributes received at block 510.

After the data and/or the hierarchy of attributes are analyzed, one or more conference rooms are suggested at block 514. The suggested conference room(s) is provided (or is caused to be provided) to the scheduling program or an output device. For example, the suggested conference room(s) can be provided to the scheduling program, and the scheduling program may cause the suggested conference room(s) to be displayed on a display. Additionally or alternatively, the suggested conference room(s) may be provided to a speaker, which produces an audio presentation of the suggested conference room(s).

Although FIGS. 1-5 are described in conjunction with an assistant program proposing conference rooms, other embodiments are not limited to an assistant program that suggests this type of a shared resource (“shared resource type”). Aspects of the disclosure can be practiced with any suitable type of a shared resource. For example, if the shared resource is automobiles, the attributes associated with that shared resource type include an automobile's make and model, the location of the automobile, the seating capacity, the number of doors, the towing capacity, a navigation system, a backup camera, hands-free options for a cellular phone, a DVD player, Wi-Fi, heated seats, and the like. The attributes of the automobiles can be arranged in a hierarchy that is analyzed by an assistant program when proposing one or more automobiles.

As another example, a shared resource may be laptop computers. The attributes associated with laptop computers include, but are not limited to, the weight, dimensions, and age of each laptop computer, the presence of USB ports, DVD drives, fingerprint sensors, whether the screen functions as a touchscreen, screen size, the amount of RAM, and various processor attributes (e.g., speed, number of processors, etc.). The attributes of the laptop computers can be arranged in a hierarchy that is analyzed by an assistant program when proposing one or more laptop computers.

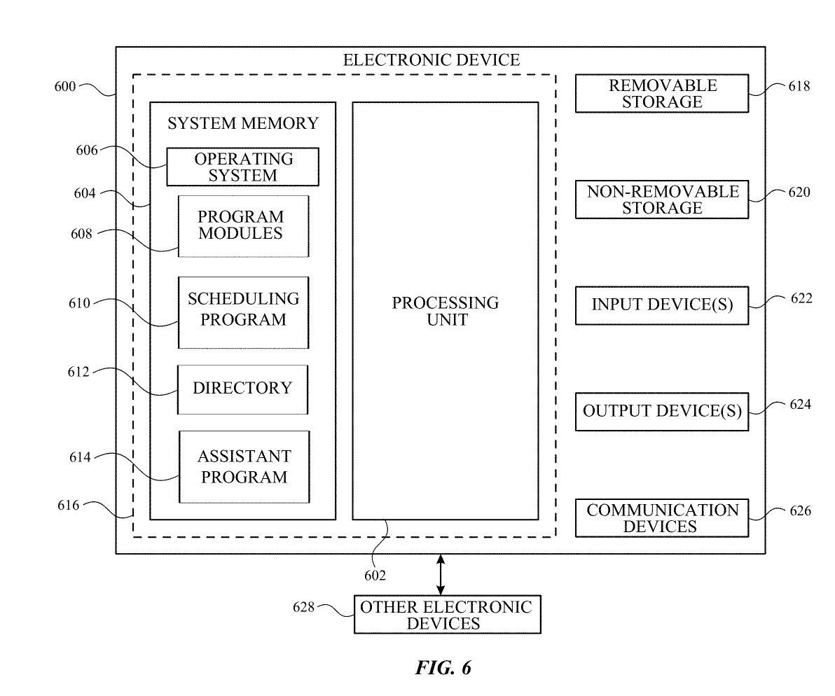

FIGS. 6-8 and the associated descriptions provide a discussion of a variety of operating environments in which aspects of the disclosure may be practiced. However, the devices and systems illustrated and discussed with respect to FIGS. 6-8 are for purposes of example and illustration and are not limiting of a vast number of electronic device configurations that may be utilized for practicing aspects of the disclosure, as described herein.

FIG. 6 is a block diagram illustrating physical components (e.g., hardware) of an electronic device 600 with which aspects of the disclosure may be practiced. The components described below may be suitable for the computing devices described above, including the client-computing device 106 and/or the server-computing device 118 in FIG. 1.

In a basic configuration, the electronic device 600 may include at least one processing unit 602 and a system memory 604. Depending on the configuration and type of the electronic device, the system memory 604 may comprise, but is not limited to, volatile storage (e.g., random access memory), non-volatile storage (e.g., read-only memory), flash memory, or any combination of such memories. The system memory 604 may include a number of program modules and data files, such as an operating system 606, one or more program modules 608 suitable for parsing received input, determining subject matter of received input, determining actions associated with the input and so on, a scheduling program 610, a directory 612, and/or an assistant program 614. While executing on the processing unit 602, the data stored in the directory (e.g., a hierarchy of attributes) and the instructions in the scheduling program 610 and the assistant program 614 may perform and/or cause to be performed processes including, but not limited to, the aspects as described herein.

The operating system 606, for example, may be suitable for controlling the operation of the electronic device 600. Furthermore, embodiments of the disclosure may be practiced in conjunction with a graphics library, other operating systems, or any other application program and is not limited to any particular application or system. This basic configuration is illustrated in FIG. 6 by those components within a dashed line 616.

The electronic device 600 may have additional features or functionality. For example, the electronic device 600 may also include additional data storage devices (removable and/or non-removable) such as, for example, magnetic disks, optical disks, or tape. Such additional storage is illustrated in FIG. 6 by a removable storage device 618 and a non-removable storage device 620.

The electronic device 600 may also have one or more input device(s) 622 such as a keyboard, a trackpad, a mouse, a pen, a sound or voice input device, a touch, force and/or swipe input device, etc. The output device(s) 624 such as a display, speakers, a printer, etc. may also be included. The aforementioned devices are examples and others may be used. The electronic device 600 may include one or more communication devices 626 allowing communications with other electronic devices 628. Examples of suitable communication devices 626 include, but are not limited to, radio frequency (RF) transmitter, receiver, and/or transceiver circuitry; universal serial bus (USB), parallel, and/or serial ports.

The term computer-readable media as used herein may include computer storage media. Computer storage media may include volatile and nonvolatile, removable and non-removable media implemented in any method or technology for storage of information, such as computer readable instructions, data structures, or program modules.

The system memory 604, the removable storage device 618, and the non-removable storage device 620 are all computer storage media examples (e.g., memory storage or storage device). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the electronic device 600. Any such computer storage media may be part of the electronic device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit.

When operating via an SOC, the functionality, described herein, with respect to the capability of client to switch protocols may be operated via application-specific logic integrated with other components of the electronic device 600 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

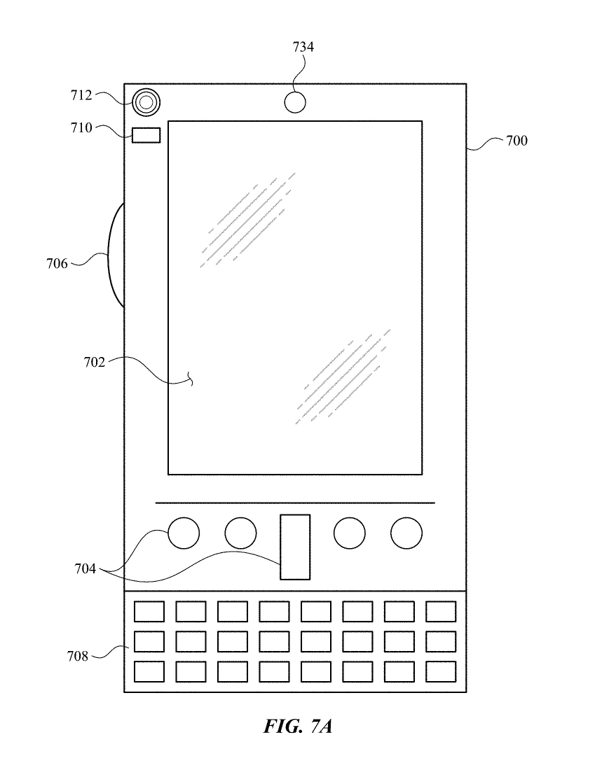

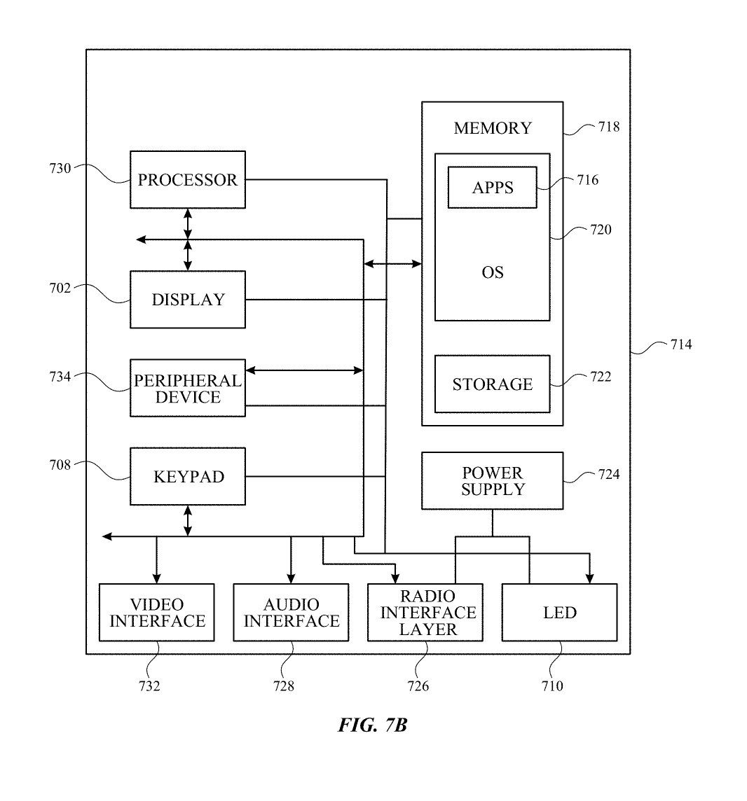

FIGS. 7A and 7B illustrate a mobile electronic device 700, for example, a mobile telephone, a smart phone, wearable computer (such as a smart watch), a tablet computer, a laptop computer, and the like, with which embodiments of the disclosure may be practiced. With reference to FIG. 7A, one aspect of a mobile electronic device 700 for implementing the aspects is illustrated.

In a basic configuration, the mobile electronic device 700 is a handheld computer having both input elements and output elements. The mobile electronic device 700 typically includes a display 702 and one or more input buttons 704 that allow the user to enter information into the mobile electronic device 700. The display 702 of the mobile electronic device 700 may also function as an input device (e.g., a display that accepts touch and/or force input).

If included, an optional side input element 706 allows further user input. The side input element 706 may be a rotary switch, a button, or any other type of manual input element. In alternative aspects, mobile electronic device 700 may incorporate more or less input elements. For example, the display 702 may not be a touch screen in some embodiments. In yet another alternative embodiment, the mobile electronic device 700 is a portable phone system, such as a cellular phone. The mobile electronic device 700 may also include an optional keypad 708. Optional keypad 708 may be a physical keypad or a “soft” keypad generated on the touch screen display.

In various embodiments, the output elements include the display 702 for showing a graphical user interface (GUI) and a set of available templates, a visual indicator 710 (e.g., a light emitting diode), and/or an audio transducer 712 (e.g., a speaker). In some aspects, the mobile electronic device 700 incorporates a vibration transducer for providing the user with tactile feedback. In yet another aspect, the mobile electronic device 700 incorporates input and/or output ports, such as an audio input (e.g., a microphone jack), an audio output (e.g., a headphone jack), and a video output (e.g., a HDMI port) for sending signals to or receiving signals from an external device.

FIG. 7B is a block diagram illustrating the architecture of one aspect of a mobile electronic device 700. That is, the mobile electronic device 700 can incorporate a system (e.g., an architecture) 714 to implement some aspects. In one embodiment, the system 714 is implemented as a “smart phone” capable of running one or more applications (e.g., browser, e-mail, calendaring, contact managers, messaging clients, games, media clients/players, content selection and sharing applications and so on). In some aspects, the system 714 is integrated as an electronic device, such as an integrated personal digital assistant (PDA) and wireless phone.

One or more application programs 716 may be loaded into the memory 718 and run on or in association with the operating system 720. Examples of the application programs include phone dialer programs, e-mail programs, personal information management (PIM) programs, word processing programs, spreadsheet programs, Internet browser programs, messaging programs, and so forth.

The system 714 also includes a non-volatile storage area 722 within the memory 718. The non-volatile storage area 722 may be used to store persistent information that should not be lost if the system 714 is powered down.

The application programs 716 may use and store information in the non-volatile storage area 722, such as email, attachments or other messages used by an email application, and the like. A synchronization application (not shown) also resides on the system 714 and is programmed to interact with a corresponding synchronization application resident on a host computer to keep the information stored in the non-volatile storage area 722 synchronized with corresponding information stored at the host computer.

The system 714 has a power supply 724, which may be implemented as one or more batteries. The power supply 724 may further include an external power source, such as an AC adapter or a powered docking cradle that supplements or recharges the batteries.

The system 714 may also include a radio interface layer 726 that performs the function of transmitting and receiving radio frequency communications. The radio interface layer 726 facilitates wireless connectivity between the system 714 and the “outside world,” via a communications carrier or service provider. Transmissions to and from the radio interface layer 726 are conducted under control of the operating system 720. In other words, communications received by the radio interface layer 726 may be disseminated to the application programs 716 via the operating system 720, and vice versa.

The visual indicator 710 may be used to provide visual notifications, and/or an audio interface 728 may be used for producing audible notifications via an audio transducer (e.g., audio transducer 712 illustrated in FIG. 7A). In the illustrated embodiment, the visual indicator 710 is a light emitting diode (LED) and the audio transducer 712 may be a speaker. These devices may be directly coupled to the power supply 724 so that when activated, they remain on for a duration dictated by the notification mechanism even though the processor 730 and other components might shut down for conserving battery power. The LED may be programmed to remain on indefinitely until the user takes action to indicate the powered-on status of the device.

The audio interface 728 is used to provide audible signals to and receive audible signals from the user (e.g., voice input such as described above). For example, in addition to being coupled to the audio transducer 712, the audio interface 728 may also be coupled to a microphone to receive audible input, such as to facilitate a telephone conversation. In accordance with embodiments of the present disclosure, the microphone may also serve as an audio sensor to facilitate control of notifications, as will be described below.

The system 714 may further include a video interface 732 that enables an operation of peripheral device 734 (e.g., on-board camera) to record still images, video stream, and the like.

A mobile electronic device 700 implementing the system 714 may have additional features or functionality. For example, the mobile electronic device 700 may also include additional data storage devices (removable and/or non-removable) such as, magnetic disks, optical disks, or tape. Such additional storage is illustrated in FIG. 7B by the non-volatile storage area 722.

Data/information generated or captured by the mobile electronic device 700 and stored via the system 714 may be stored locally on the mobile electronic device 700, as described above, or the data may be stored on any number of storage media that may be accessed by the device via the radio interface layer 726 or via a wired connection between the mobile electronic device 700 and a separate electronic device associated with the mobile electronic device 700, for example, a server-computing device in a distributed computing network, such as the Internet (e.g., server-computing device 110 or 118 in FIG. 1). As should be appreciated such data/information may be accessed via the mobile electronic device 700 via the radio interface layer 726 or via a distributed computing network. Similarly, such data/information may be readily transferred between electronic devices for storage and use according to well-known data/information transfer and storage means, including electronic mail and collaborative data/information sharing systems.

As should be appreciated, FIG. 7A and FIG. 7B are described for purposes of illustrating the present methods and systems and is not intended to limit the disclosure to a particular sequence of steps or a particular combination of hardware or software components.

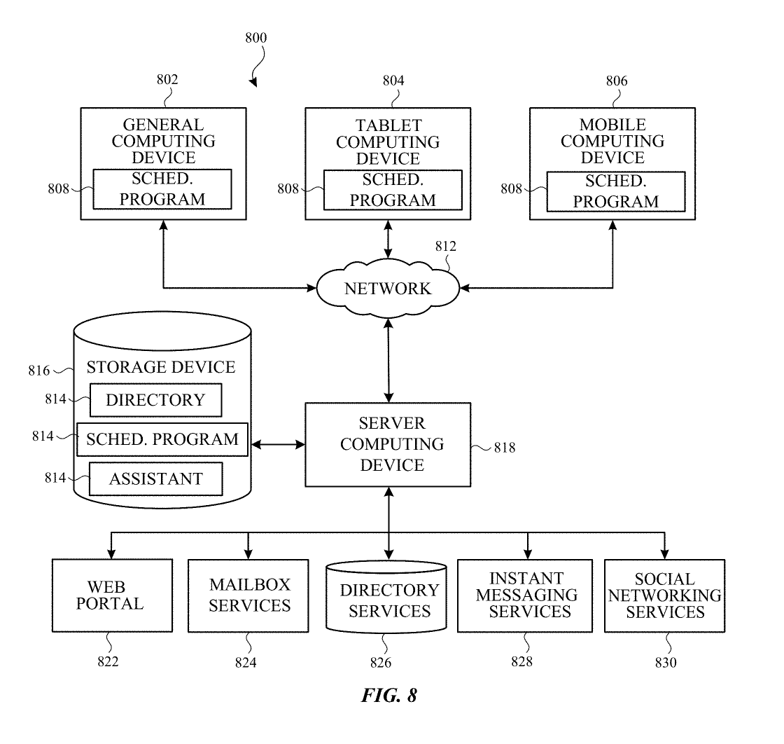

FIG. 8 is a block diagram illustrating a distributed system in which aspects of the disclosure may be practiced. The system 800 allows a user to send and receive electronic communications that include one or more attachments through a general computing device 802 (e.g., a desktop computer), a tablet computing device 804, and/or a mobile computing device 806. The general computing device 802, the tablet computing device 804, and the mobile computing device 806 can each include the components, or be connected to the components, that are shown associated with the electronic device 600 in FIG. 6. Additionally, the general computing device 802, the tablet computing device 804, and the mobile computing device 806 each include an electronic communications application 808 and optionally an MBA application 810.

The general computing device 802, the tablet computing device 804, and the mobile computing device 806 are each configured to access one or more networks (represented by network 812) to interact with the electronic communications application 814 stored in one or more storage devices (represented by storage device 816) and executed on one or more server-computing devices (represented by server-computing device 818). The electronic communication application 814 can access, call, or work with the MBA application 820 stored on the storage deice 816 and executed on the server-computing device 818 when the electronic communication application 814 is used to generate and/or send an electronic communication that includes one or more attachments.

In some aspects, the server-computing device 818 can access and/or receive various types of services, communications, documents and information transmitted from other sources, such as a web portal 822, an electronic communications services 824, mailbox services 826, instant messaging and/or text services 828, and/or social networking services 824. In some instances, these sources may provide robust reporting, analytics, data compilation and/or storage service, etc., whereas other services may provide search engines or other access to data and information, images, videos, document processing and the like.

In some embodiments, when the general computing device 802, the tablet computing device 804, and/or the mobile computing device 806 include the MBA application 810, the electronic communications program 808 can call, access, or work with at least one MBA application 810. Thus, the operations of generating an electronic communication (e.g., email), attaching one or more attachments to the electronic communication, providing a representational element for each attachment, providing an HR attachment thumbnail for each attachment, and replacing at least one representational element with a corresponding HR attachment thumbnail may be performed by general computing device 802, the tablet computing device 804, and the mobile computing device 806. For example, a user (sender) can use the electronic communications application 808 on one computing device to send an attachment and an email with a representational element representing the attachment and the MBA application 810 on the same or another computing device can provide an HR attachment thumbnail for the attachment and replace the representational element with the HR attachment thumbnail.

As should be appreciated, FIG. 8 is described for purposes of illustrating the present methods and systems and is not intended to limit the disclosure to a particular sequence of steps or a particular combination of hardware or software components.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A system, comprising:
one or more processing units; and
one or more storage devices storing:
a directory comprising shared resources and a hierarchy of attributes associated with the shared resources; and
instructions that when executed by the one or more processing units, cause the one or more processing units to perform a method comprising:
receiving a request to schedule a particular shared resource type that is included in the directory;
receiving one or more selected attributes associated with the particular shared resource type;
analyzing the hierarchy of attributes associated with the particular shared resource type to determine one or more shared resources of the particular shared resource type that correspond to the one or more selected attributes; and
based at least on the analysis, determining at least one shared resource of the particular shared resource type to suggest.

2. The system of claim 1, further comprising an output device operably connected to the one or more processing units, wherein the method further comprises causing the suggested at least one shared resource to be provided to the output device.

3. The system of claim 2, wherein the output device comprises a display.

4. The system of claim 1, wherein:
the one or more storage devices further store a scheduling program to schedule the shared resource; and
the method further comprises causing the suggested at least one shared resource to be provided to the output device.

5. The system of claim 1, further comprising a communication device, wherein the operation of receiving the request to schedule the particular shared resource type comprises receiving, over a network using the communication device, the request to schedule the particular shared resource type that is included in the directory.

6. The system of claim 5, wherein the system comprises a server-computing device.

7. The system of claim 1, wherein the particular shared resource type comprises conference rooms.

8. A method, comprising:
receiving, from a scheduling program, a request to schedule a conference room, the conference room included in a plurality of conference rooms;
in response to the request, analyzing a hierarchy of attributes associated with the plurality of conference rooms to determine which conference rooms in the plurality of conference rooms correspond to one or more selected attributes;
determining at least one conference room to suggest based at least in part on the analysis; and
providing the suggested at least one conference room to the scheduling program.

9. The method of claim 8, further comprising prior to determining the at least conference room to suggest, determining a history of prior use for each conference room in the plurality of conference rooms, wherein the determination of the at least one conference room to suggest is further based on the history of prior use.

10. The method of claim 8, further comprising prior to determining the at least conference room to suggest, determining a distance between each conference room in the plurality of conference rooms and a requestor, wherein the determination of the at least one conference room to suggest is further based on the determined distances.

11. The method of claim 8, wherein the request to schedule the conference room is included in a request to schedule a meeting.

12. The method of claim 11, further comprising:
receiving one or more attendees to the meeting;
determining a distance between each conference room and a requestor; and
determining a distance between each conference room and each attendee, wherein the determination of the at least one conference room to suggest is further based on the determined distances associated with the requestor and the one or more attendees.

13. The method of claim 8, wherein the operation of analyzing the hierarchy of attributes comprises analyzing the hierarchy of attributes associated with the plurality of conference rooms to determine which conference rooms in the plurality of conference rooms correspond to one or more selected attributes and to one or more unselected attributes.

14. A method, comprising:
receiving a request to schedule a meeting in a conference room;
determining a location of the requestor and a location of each conference room in a plurality of conference rooms;
determining a distance between the location of the requestor and a location of each conference room;
receiving one or more selected attributes associated with the plurality of conference rooms;
analyzing a hierarchy of attributes associated with the one or more conference rooms to determine which conference rooms correspond to the selected attributes; and
based at least in part on the analysis and the determined distances, determining one or more conference rooms to suggest for the meeting.

15. The method of claim 14, wherein the attributes comprise at least one of:
a location;
one or more pieces of equipment;
a capacity; or
a seating layout.

16. The method of claim 15, wherein the attributes comprise a default list of attributes.

17. The method of claim 15, wherein the attributes comprise a none option.

18. The method of claim 14, further comprising:
receiving one or more attendees to the meeting;
determining a location of each attendee; and
determining, for each attendee, a distance between the location of the attendee and the location of each conference room, wherein the operation of determining the one or more conference rooms to suggest for the meeting is further based on the determined distances associated with attendees.

19. The method of claim 14, further comprising determining, for the requestor, a history of prior use for each conference room, wherein the operation of determining the one or more conference rooms to suggest for the meeting is further based on the history of prior use.

20. The method of claim 14, further comprising:
prior to analyzing the hierarchy of attributes, receiving one or more selected attributes.
